(19) United States
(12) Patent Application Publication
(10) Pub. No.: US 2025/0176050 A1
(43) Pub. Date: May 29, 2025

(54) Methods and Apparatus for Implementing a High Connection Availability Network

(71) Applicant: Charter Communications Operating, LLC, St. Louis, MO (US)

(72) Inventor: Deh-Min Richard Wu, Centennial, CO (US)

(21) Appl. No.: 18/523,779

(22) Filed: Nov. 29, 2023

(51) Int. Cl. H04W 76/16; H04W 8/20; H04W 60/04

(52) U.S. Cl. CPC H04W 76/16; H04W 8/20; H04W 60/04

(57) ABSTRACT

A MSO subscriber UE obtains wireless access via a partner MNO, with which the MSO has an agreement allowing use of the MNO's RANs and further allowing and supporting MSO core network to MNO core network interworking connections. An MSO subscriber UE, which obtains access via the partner MNO RAN, uses both the MNO core and the MSO core for the communications. The use of both the MNO core and the MSO core allows the MNO core to fine tune RAN operation and allows the MSO core to maintain overall control of AAA operations and control service to its UEs. The UE initiates registration via the RAN and its MNO core; however, a MSO core node entity (CNE) is selected and signaling is rerouted to the selected MSO CNE, with the RAN and the MNO acting then as proxies, and the MSO core controlling service with regard to the UE.

### FIELD

The present application relates to wireless communications systems, and more particularly, to methods and apparatus for supporting efficient communications for Multiple System Operator (MSO) subscriber UEs, which are obtaining wireless access via a partner Mobile Network Operator (MNO) radio access network (RAN), using core to core interworking connections.

### BACKGROUND

A traditional wireline operator with DSL (Digital Subscriber Line), DOCSIS (Data Over Cable Service Interface Specification) and FTTP (Fiber to the Premises) deployment can support a large degree of residential and business connectivity, but typically lacks mobility coverage outside their premises. When a cable operator (Internet operator) extends their business to include mobile service, there is a problem as to how to provide service to their mobile customers, as part of being a Multiple Service Operator (MSO) which includes mobile service. The MSO operator needs to be able to provide sufficient nationwide coverage to its mobile subscribers. There are available options to being able to provide sufficient nationwide coverage, and one important strategy is to lease another mobile network operator's radio access network.

The MSO, which provides wireless coverage, typically signs MOCN (Multi-Operator Core Network) agreements with MNO (Mobile Network Operator) partners to share their RAN (radio access network) with the MSO core. There is a problem in that normally a MNO's RAN is configured and tuned to MNO core call setup. The MSO core may have some gaps with regard to being able to manage, e.g., efficiently manage, a MNO's RAN.

The MSO, which provides wireless coverage, typically signs a MVNO (Mobile Virtual Network Operator (MVNO) business contract with the MNO to be able to use their infrastructure. This solution does not define interworking between MSO infrastructure and MNO's network.

Without involving MNO core in the call set up can cause many aspects being less performant, e.g., service disruption may occur, continuous operation may be less reliable, and QoE (Quality of Experience) may be degraded.

Although the MSO can connect to all MNO RAN nodes, of the MNO network with which the MSO has an agreement, a huge CAPEX (capital expenditure) investment in core-node: RAN-node=1:N links is needed on the part of the MSO for such an implementation. The MSO would need to deploy and OAM (operate and manage) huge amounts of links between the two operators (MSO and MNO), and this is a permanent OPEX (operating expense) spending.

FIG. 1 is drawing 50 illustrating a prior art approach which allows a MSO, operating with a MNO, with which it has an existing MOCN agreement 55, to utilize the MNO's RAN 66. Service provider S, which is a multiple system operator (MSO), has MSO S network infrastructure 54 including access point (AP) 60, e.g., a WiFi AP, wireline access node (AN) 62, and MSO S 5G core (5GC) 64. The AP 60 and wireline AN 62 are coupled to the 5GC 64 via communications link 74. Service provider N, which is a mobile network operator (MNO), has MNO N network infrastructure 56 including radio access network (RAN) 66, e.g., a gNB base station, and MNO 5GC 68. RAN 66 is coupled to the MNO N 5GC 68 via communications link 78. Service provider C, e.g., an IMS service provider, includes service provider C network infrastructure 58 including a node 70 including a service provider C APP, e.g., an IMS APP. The MSO S 5GC 64 is coupled to the service provider C APP node 70 via communications link 80. It should be appreciated that drawing 50 is a simplified version of an exemplary system including MSO and MNO infrastructure and only shows a limited number of elements for simplicity of explanation; however, the MNO N network typically includes a large number of RANs, and the MSO S network typically includes a larger number of UE subscriber devices, which may seek to obtain access via the RANs of MNO N.

Exemplary UE 52 is a UE which subscribes to MSO S. MSO S and MNO N have a MOCN agreement 55. When UE 52 is at home, UE 52 can be served via the MSO S AP 60 or wireline AN 62, e.g., via wireless or wireline connection 72. However, when UE 52 moves outside MSO's access coverage areas, e.g., outside its home coverage area, UE 52 cannot be connected through the access devices (60, 62) of MSO S.

UE 52, is shown as UE 52′, after the UE 52 moves to within the wireless coverage area of RAN 60, e.g., a gNB, of MNO N. UE 52′ obtains a wireless connection 76 with RAN 66. The UE 52′ can obtain access through MNO N's RAN 66 and MSO S's 5GC 64 without involving MNO N's 5GC 58. This approach involves a link 82 between RAN 66 of MNO N and the MSO S 5GC 64. One problem with this approach is that there is no service control of UE network N's core 68. Another problem with this approach is that it will require lots of deployments of direct links between MSO S 5G core to RAN nodes of MNO N in a typical system, in which there are a large number of MSO subscriber UEs and a large number of MNO RANs.

Based on the above discussion, there is a need for new methods and apparatus for supporting a MSO network, which has wireless subscribers, to be able to utilize radio access networks of MNOs in a reliable, cost effective and/or efficient manner.

### SUMMARY

Methods and apparatus, in accordance with the present invention, are directed to facilitating a multiple system operator (MSO) to efficiently expand wireless coverage offered to its subscribers and provide a high level of quality service. MSO subscriber UEs may, and sometimes do, obtain wireless access via a partner MNO, with which the MSO has an agreement allowing use of the MNO's radio access networks (RANs) and further allowing and supporting MSO core network to MNO core network interworking connections. A MSO subscriber UE, which obtains access via the partner MNO RAN, uses both the MNO core and the MSO core for the communications. The use of both the MNO core and the MSO core allows the MNO core to fine tune RAN operation and allows the MSO core to maintain overall control of AAA operations and control service to its UEs. The UE initiates registration via the RAN and its MNO core; however, a MSO core node entity (CNE) is selected and signaling is rerouted to the selected MSO CNE, with the RAN and the MNO acting then as proxies, and the MSO core controlling service with regard to the UE.

A communications method, in accordance with some embodiments, comprises: operating a mobile network operator (MNO) core network entity to initiate a user equipment (UE) interworking operation with a multiple system operator (MSO) core network by sending an initiate message communicating an attach request corresponding to a first UE to a first MSO core entity which has access to first UE subscription data; and operating the first MSO core network entity to command the MNO core network entity to use a second MSO core network entity, which is an MSO network interworking entity, for UE policy information to be applied to service provided to the first UE.

While various features are discussed in the above summary, all features discussed above need not be supported in all embodiments and numerous variations are possible. Numerous additional features, details and embodiments are described in the detailed description below.

### BRIEF DESCRIPTION OF THE FIGURES

FIG. 1 is drawing illustrating a prior art approach which allows a MSO, operating with a MNO, with which it has an existing MOCN agreement, to utilize the MNO's RAN.

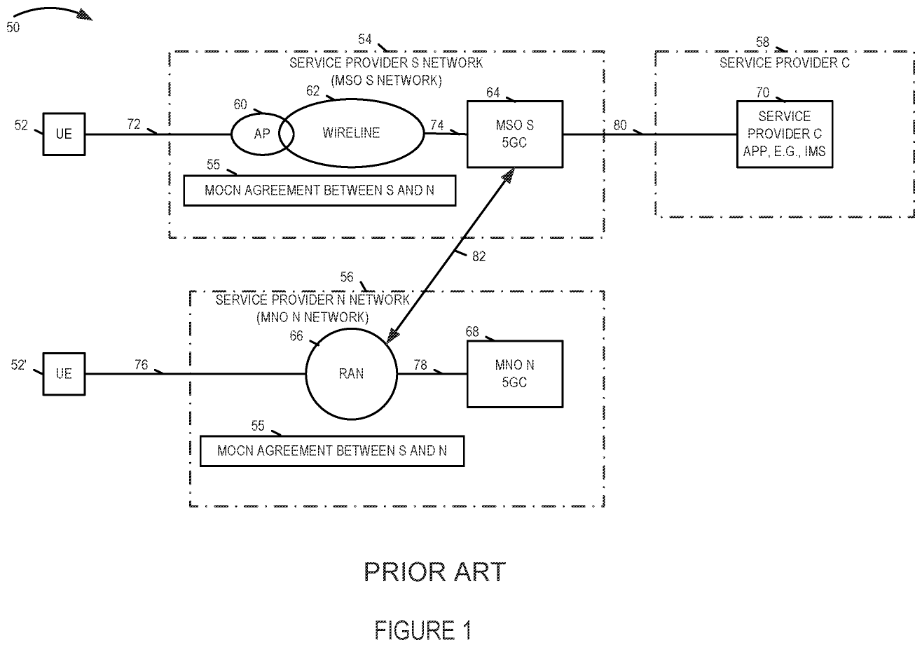

FIG. 2 is drawing illustrating an approach, in accordance with the present invention, which allows a MSO, operating with a MNO, with which it has an existing MOCN agreement which allows both MSO core and MNO core to interwork, to efficiently utilize the MNO's RAN.

FIG. 3 illustrates an example a MSO, which has service agreements with two MNOs which allows interworking between cores, to utilize the RANs of the two MNOs to support wireless communications for its subscribers in an efficient and cost effective manner, in accordance with the present invention.

FIG. 4 is a drawing of an exemplary communications system in accordance with an exemplary embodiment, said exemplary system communications system including a MNO network and a MSO network and supporting interworking connections between the MNO core and the MSO core.

FIG. 5A is a first part of a signaling diagram illustrating an exemplary method of operating a communications system in accordance with an exemplary embodiment.

FIG. 5B is a second part of a signaling diagram illustrating an exemplary method of operating a communications system in accordance with an exemplary embodiment.

FIG. 5C is a third part of a signaling diagram illustrating an exemplary method of operating a communications system in accordance with an exemplary embodiment.

FIG. 5D is a fourth part of a signaling diagram illustrating an exemplary method of operating a communications system in accordance with an exemplary embodiment.

FIG. 5 comprises the combination of FIG. 5A, FIG. 5B, FIG. 5C and FIG. 5D.

FIG. 6 is a drawing of an exemplary MNO core network entity (CNE) in accordance with an exemplary embodiment.

FIG. 7 is a drawing of an exemplary first MSO core network entity (CNE) in accordance with an exemplary embodiment.

FIG. 8 is a drawing of an exemplary second MSO core network entity (CNE) in accordance with an exemplary embodiment.

FIG. 9 is a drawing of an exemplary user equipment (UE) in accordance with an exemplary embodiment.

FIG. 10 is a drawing of an exemplary radio access network (RAN), e.g., a MNO gNB base station, in accordance with an exemplary embodiment.

### DETAILED DESCRIPTION

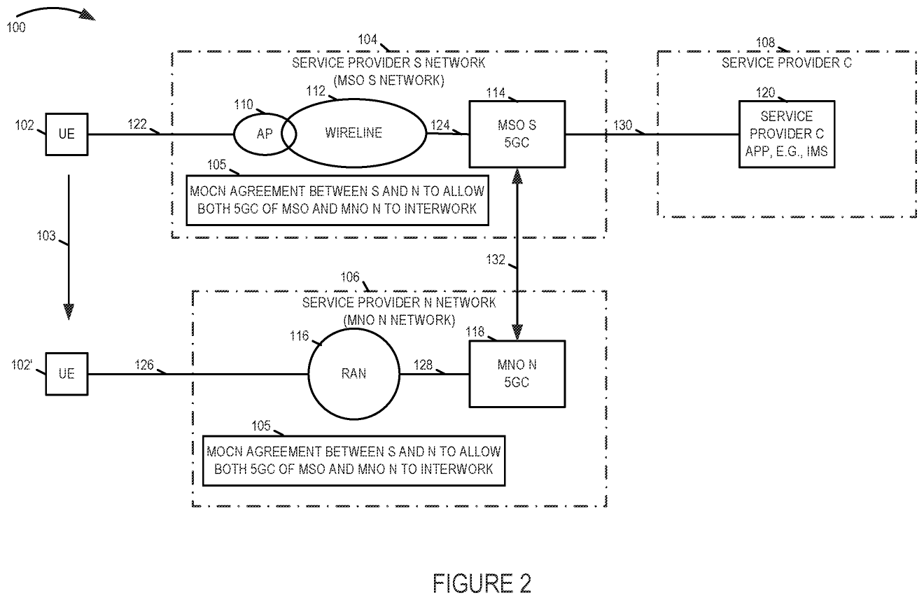

FIG. 2 is drawing 100 illustrating an approach, in accordance with the present invention, which allows a MSO, operating with a MNO, with which it has a MOCN agreement which allows the MSO to use the RANs of the MNO and allows both MSO core and MNO core to interwork, to efficiently utilize the MNO's RAN.

Service provider S, which is a multiple system operator (MSO), has MSO S network infrastructure 104 including access point (AP) 110, e.g., a WiFi AP, wireline access node (AN) 112, and MSO S 5G core (5GC) 114. The AP 110 and wireline AN 112 are coupled to the MSO 5GC 114 via communications link 124. Service provider N, which is a mobile network operator (MNO), has MNO N network infrastructure 106 including radio access network (RAN) 116, e.g., a gNB base station, and MNO 5GC 118. RAN 116 is coupled to the MNO N 5GC 118 via communications link 128. Service provider C, e.g., an IMS service provider, includes service provider C network infrastructure 108 including a node 120 including a service provider C APP, e.g., an IMS APP. The MSO S 5GC 114 is coupled to the service provider C APP node 120 via communications link 130.

Exemplary UE 102 is a UE which subscribes to MSO S. MSO S and MNO N have a MOCN agreement 105 which allows MSO subscriber UEs to use the RANs of MNO N and allows both the MSO S 5GC 114 and MNO N 5GC 118 to interwork. When UE 102 is at home, UE 102 can be served via the MSO S's AP 110 or wireline AN 112, e.g., via wireless or wireline connection 122. However, when UE 102 moves outside MSO's access coverage areas, e.g., outside its home coverage area, UE 102 cannot be connected through the access devices (110, 112) of MSO S.

UE 102, is shown as UE 102′, after the UE 102 moves to within the wireless coverage area of RAN 106, e.g., a gNB, of MNO N. UE 102 gets a connection 126 via MNO's shared RAN 116. The two core networks (MNO N 5GC 118 and MSO S 5GC 114) interwork to set up a call. Bi-directional arrow 132 represents an interworking link between the two core networks (118, 132). MSO S's 5GC 114 determines subscription data, service access and traffic policy. The UE can access service from service provider C via interwork of both core networks from MSO to MNO.

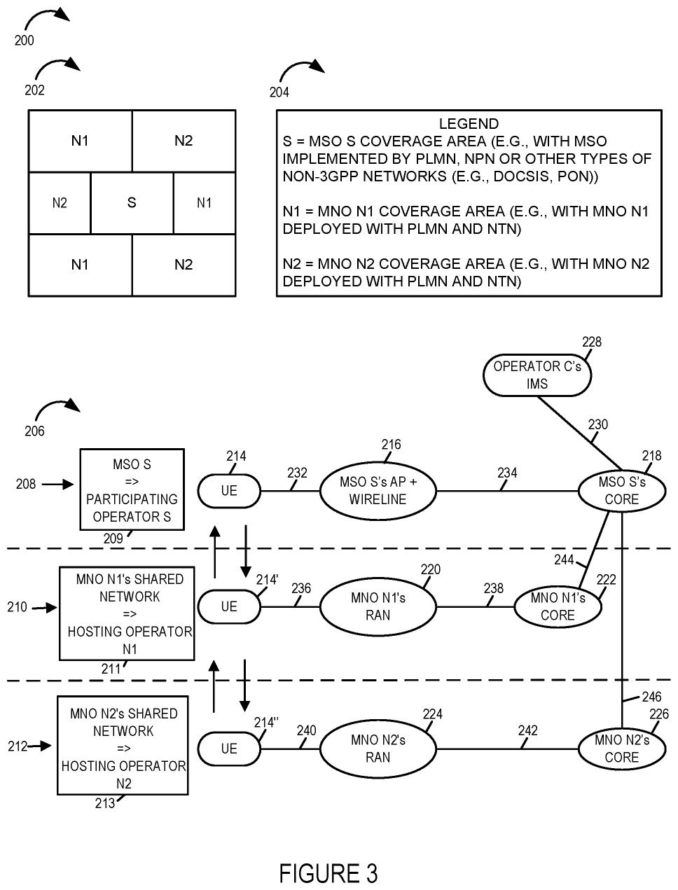

FIG. 3 including drawing 200 which illustrates an example a MSO, which has service agreements with two MNOs which allows interworking between cores, to utilize the RANs of the two MNOs to support wireless communications for its subscribers in an efficient and cost effective manner, in accordance with the present invention. S, N1, and N2 are three operators with networks and corresponding coverage areas. S is a MSO, N1 is a first MNO, and N2 is a second MNO. Drawing 202 illustrates the corresponding coverage areas for each of the service provider operators (S, N1, N2). Legend 204 corresponding to coverage area map 202. Legend 204 indicates: i) S within map 202 indicates a MSO S coverage area, e.g. with MSO implemented by PLMN, NPN or other types of Non-3GPP networks (e.g., DOCSIS, PON), ii) N1 within map 202 indicates a MNO N1 coverage area, e.g., with MNO N1 deployed with PLMN and NTN; and iii) N2 within map 202 indicates a MNO N2 coverage area, e.g., with MNO N2 deployed with PLMN and NTN.

Drawing 206 illustrates an exemplary system including MSO S network infrastructure, MNO N1 infrastructure, MNO N2 infrastructure, and operator C's IMS 228 coupled together. MSO S network infrastructure includes MSO S's AP+wireless access device(s) 216 coupled to MSO S′ core 218 via link 234. MNO N1 network infrastructure includes MNO N1's RAN 220 216 coupled to MNO N1's core 222 via link 238. MNO N2 network infrastructure includes MNO N2's RAN 224 coupled to MNO N2's core 226 via link 242. In accordance with a feature of the current invention, there is an interworking connection 244 between MNO N1's core 222 and MSO S's core 218. In accordance with a feature of the current invention, there is an interworking connection 246 between MNO N2's core 226 and MSO S's core 218. MSO's core 218 is further coupled to operator C's IMS 228 via communications link 230.

UE 214, which is a MSO S subscriber UE, may move throughout the system and be connected to different access devices of different operators at different times.

Drawing 206 further illustrates an exemplary MSO subscriber UE 214, which can obtain access via the access network infrastructure of each of MSO S, MNO N1, and MNO N2, e.g., depending upon its location. In this example, the UE 214 is represented as UE 214 when in the coverage area of MSO S and is connected to MSO's AP or wireline AN device via communications link 232; UE 214 is represented as UE 214′ when in the coverage area of MNO N1 and is connected to MNO N1's RAN 220 via wireless communications link 236; and UE 214 is represented as UE 214″ when in the coverage area of MNO N2 and is connected to MNO N2's RAN 224 via wireless communications link 240.

In the example of drawing 206, the UE moves from the coverage area of the MSO S to the coverage area of MNO N1, and then to the coverage area of MNO N2. In area 208, the UE 214 is using MSO network infrastructure for communications, e.g., with a path from UE 214 to operator C IMS 228 including: communications link 232, MSO S's AP+wireline device 216, communications link 234, MSO S core 218 and communications link 230. MSO S is a participating operator as indicated by box 209.

In area 210, the UE 214′ is using MNO N1 network infrastructure in combination with MSO S core 218 for communications, e.g., with a path from UE 214′ to operator C IMS 228 including: wireless link 236, MNO N1's RAN 220, communications link 238, MNO N1's core 222, interworking connection 244, MSO S core 218 and communications link 230. MSO S is a participating operator as indicated by box 209, and MNO N1's shared network is a hosting operator network N1, as indicated by box 211.

In area 212, the UE 214″ is using MNO N2 network infrastructure in combination with MSO S core 218 for communications, e.g., with a path from UE 214 to operator C IMS 228 including: wireless link 240, MNO N2's RAN 224, communications link 242, MNO N2's core 226, interworking connection 246, MSO S core 218 and communications link 230. MSO S is a participating operator as indicated by box 209, and MNO N2's shared network is a hosting operator network N2, as indicated by box 213.

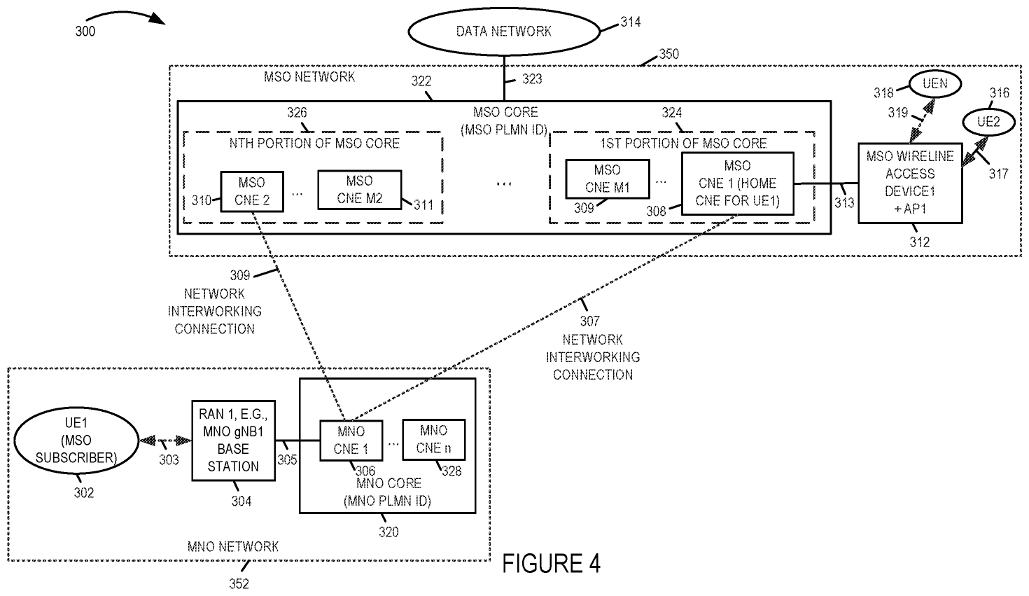

FIG. 4 is a drawing of an exemplary communications system 300 in accordance with an exemplary embodiment, said exemplary system communications system including a MSO network 350 and a MNO network 352 and supporting interworking connections (307, 309) between the MNO core 320 and the MSO core 322. Communications system 300 further includes a data network 314 coupled to the MSO core 322 via communications link 323. MSO network 350 includes access device(s) 312, which includes MSO wireline access device 1, e.g., a wireline AN, +AP 1, e.g., a WiFi AP, (which may be implemented as an integrated single device or implemented as two separate devices), and MSO core 322 coupled together via communications link 313. MSO core 322 corresponds to an MSO PLMN ID. The MSO core 322 includes a plurality of MSO core portions, e.g., corresponding to different geographic regions (1st portion of MSO core 324, . . . , Nth portion of MSO core 326). 1st portion of MSO core 324 includes a plurality of MSO core network entities (MSO CNEs) (MSO CNE 1 308 (e.g., the home CNE for UE 1 302 which has subscriber data for UE 1 302), . . . , MSO CNE M1 309). Nth portion of MSO core 326 includes a plurality of MSO CNEs (MSO CNE 2 310, . . . , MSO CNE M2 311). MNO network 352 includes radio access network 1 (RAN 1) 304, e.g., a MNO gNB base station, and MNO core 320 coupled together via communications link 305. MNO core 320 corresponds to an MNO PLMN ID. MNO core 320 includes a plurality of MNO CNEs (MNO CNE1 306, . . . , MNO CNEn 328).

Exemplary communications system 300 further includes a plurality of mobile user equipments (UEs) (UE 1 302, UE 2 316, . . . , UEN 318), which are UE subscriber devices of the MSO. UE1 302 is shown as being currently located in the coverage area of the access network of the MNO and is coupled to MNO 1 RAN 1 304 via wireless communications link 303. UE2 316 is shown as being currently located in the coverage area of the access network of the MSO and is coupled to MSO access device 312 via wireline communications link 317. UEN 318 is shown as being currently located in the coverage area of the access network of the MSO and is coupled to MSO access device 312 via wireless communications link 319.

Network interworking connection 307 connects MNO CNE 306 to MSO CNE 1 308, which is the home MSO CNE for UE 1 302. Network interworking connection 309 connects MNO CNE 306 to MSO CNE 2 310, which is a selected MNO CNE to be used for supporting UE1 302 communications.

UE1 302 communications involves MNO RAN 1 304, MNO core 320 including MNO CNE 306, core to core network interworking connections (307, 309), and MSO core 322 including MSO CNE 1 308 and MSO CNE 2 310, e.g., in accordance with the MSO/MNO operator service agreement with includes allowing MSO UE subscribers to use RANs of the MNO and further allowing interworking between the MSO core and MNO to support communications of MSO UE subscribers.

Each of the cores (MSO core 322, MNO core 320) is, e.g., a 5GC, which includes one or more instances of each of a plurality of different functions, e.g., including NSSF, NEF, NRF, NSSAAF, AUSF, AMF, PCF, UDM, AF, EASDF, SMF, SCP, NSACF, UPF.

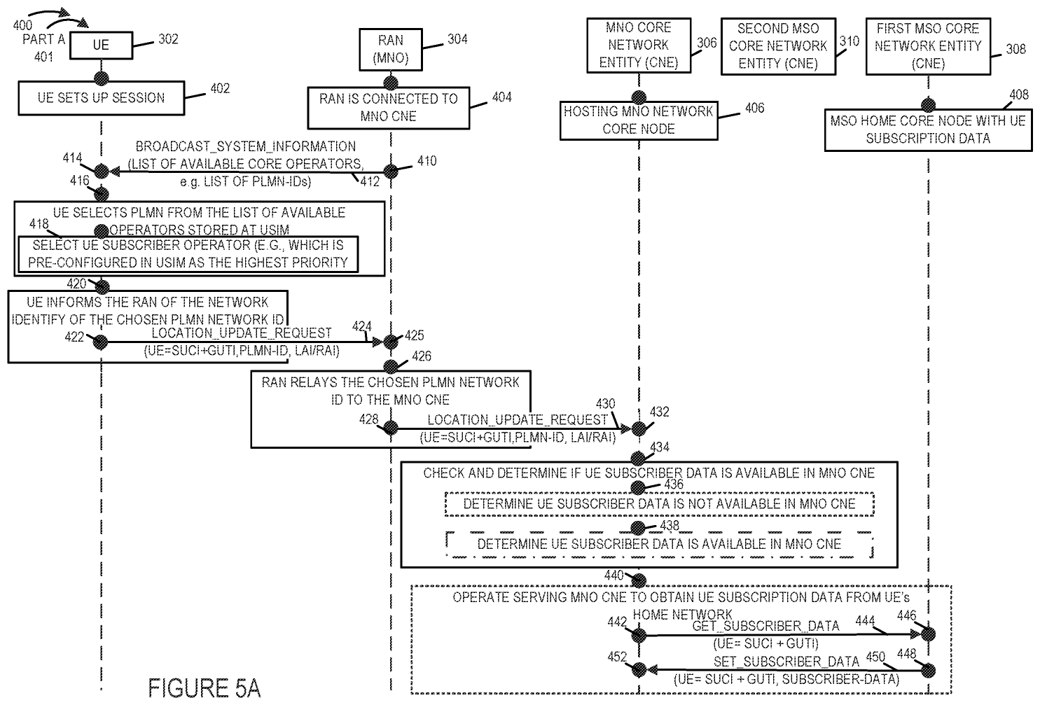

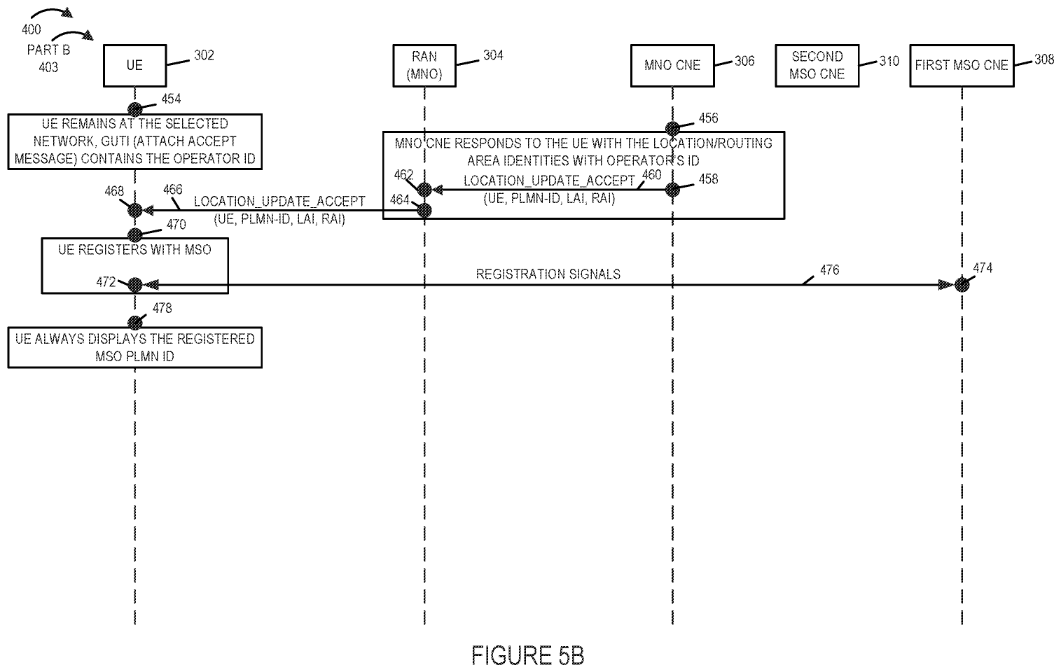

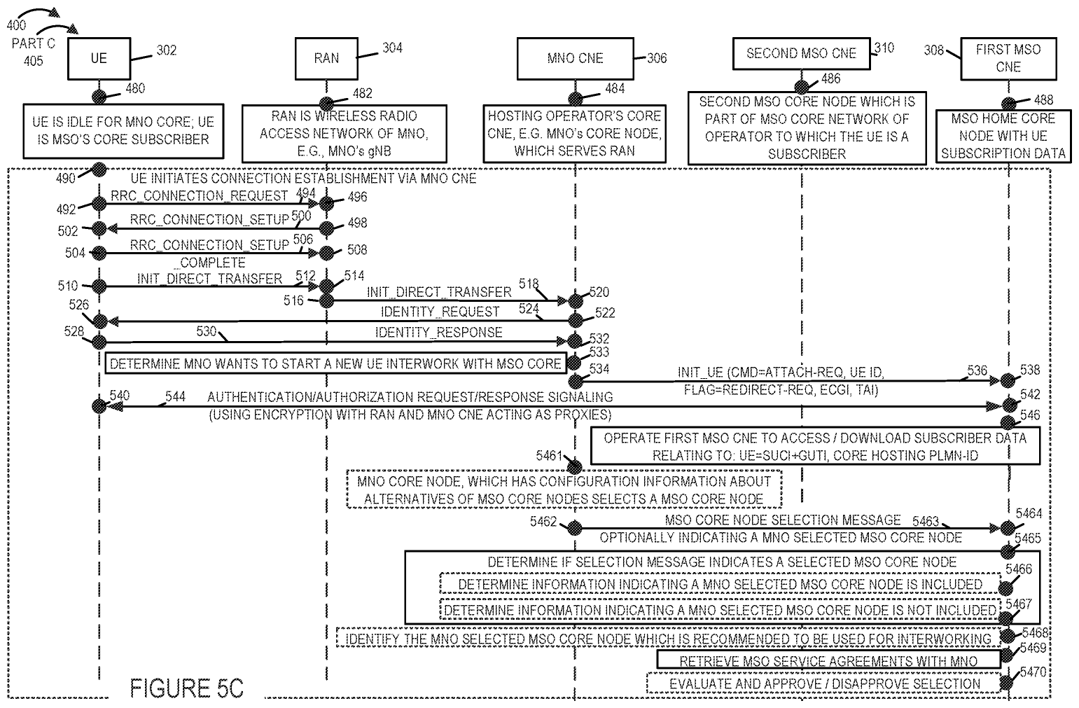

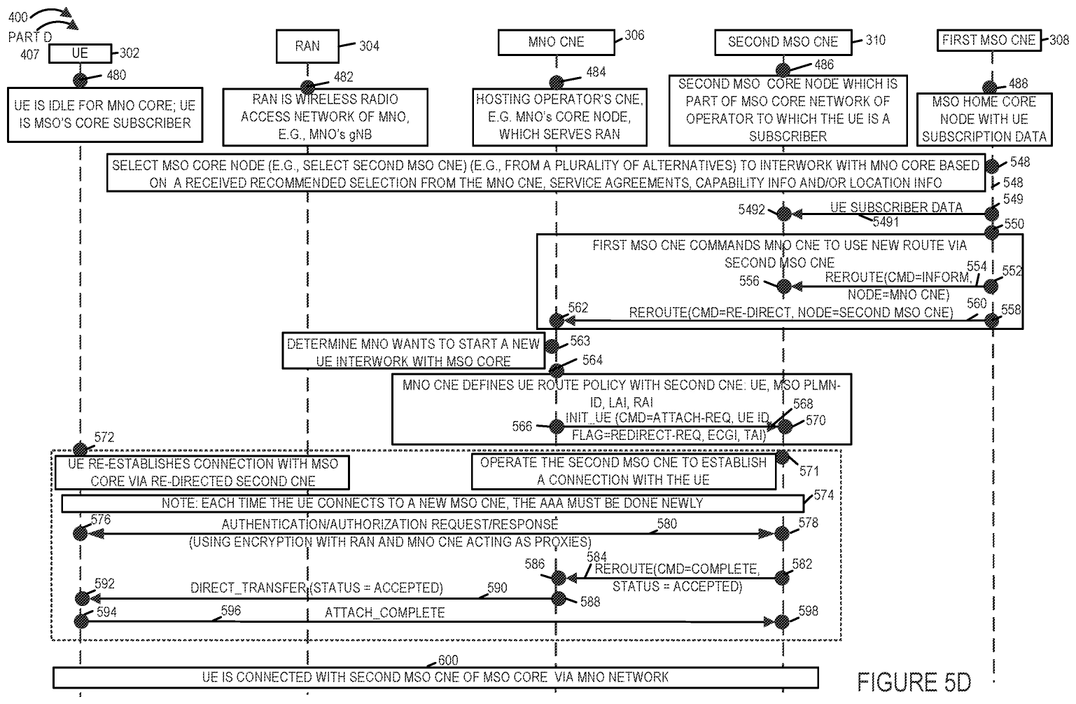

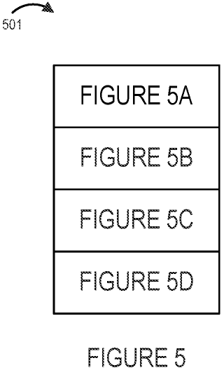

FIG. 5 is a diagram 501 showing how FIG. 5A, FIG. 5B, FIG. 5C and FIG. 5D, are to be combined to form the complete signaling diagram 400, comprising Part A 401, Part B 403, Part C 405 and Part D 407, of an exemplary method of operating a communications system in accordance with an exemplary embodiment. Signaling diagram 400 includes user equipment (UE) 302, e.g., a first UE, a radio access network (RAN) 304, e.g., a gNB base station of the MNO network, MNO core network entity (CNE) 306, first MSO core network entity (CNE) 308, and second MSO core network entity (CNE) 310. The various elements (UE 302, RAN 304, MNO CNE 306, first MSO CNE 308 and second MSO CNE 310) are part of the exemplary communication system 300 of FIG. 3. The MNO network and MSO network have an implemented agreement regarding MNO core network to MSO core network interworking. The exemplary UE 302 is operated to set up a session, as indicated by information box 402. RAN 304, which is part of the same MNO network as MNO CNE 306 is connected to MNO CNE 306, as indicated by information box 404. MNO CNE 306 is a hosting MNO network core node, as indicated by information box 406, first MSO CNE 308 is a MSO home core node with UE 302 subscription data, as indicated by information box 408.

In step 410 RAN 304 generates and transmits broadcast system information 412 which includes a list of available core operators, e.g., a list of PLMN (Public Land Mobile Network) IDs. In step 414, UE 302 which is currently in the vicinity of RAN 304, receives the broadcast system information 412 and recovers the communicated list of available core operators, e.g., the list of PLMN-IDs. The list of PLMN-IDs includes a PLMN ID corresponding to the MNO core network, to which MNO CNE 306 belongs, and a PLMM ID corresponding to the MSO core network, to which first MSO CNE 308 and second MSO CNE 310 belong.

In step 416 UE 302 selects a PLMN from, the received list of available core operators indicated in information 412, which is one of the operators stored in the UE Universal Subscriber Identity Module (USIM) of the UE 302, e.g., the UE 302 selects the PLMN having the highest priority. In some embodiments, in which the USIM includes information indicating more than one subscriber operator (e.g., more than one PLMN-ID), the PLMN-ID corresponding to the MSO, to which first MSO CNE 308 belongs, is pre-configured as having the highest priority. In some embodiments, step 416 includes step 418 in which the UE selects the subscriber operator of the MSO core, e.g., which has been pre-configured in the USIM as having the highest priority.

In step 420 UE 302 informs the RAN 304 of the chosen PLMN network ID. Step 420 includes step 422 in which the UE 302 generates and sends location update request message 424, which includes UE 302 identity information including SUCI+GUTI (Subscriber Concealed Identifier+Globally Unique Temporary Identifier), the selected PLMN-ID, which is the PLMN-ID corresponding to the MSO, and LAI/RAI (Local Area Identity/Routine Area Identification) information, to RAN 304, which receives the location update request message 424 in step 425, and recovers the communicated information. In step 426 the RAN 304 relays the chosen PLMN network ID to the MNO CNE 306. Step 426 includes step 428, in which the RAN generates and sends location update request message 430 including the UE ID information including SUCI+GUTI, the selected PLMN-ID, and the LAI/RAI. Location update request message 430 is a forwarded copy of received message 424. In step 432, the MNO CNE 306 receives location update request message 430 and recovers the communicated information.

In step 434, MNO CNE 306 checks and determines if UE subscriber data corresponding to UE 302, is available in the MNO CNE 306. An iteration of step 434 includes one of step 436, in which the MNO CNE 306 determines that UE subscriber data is not available in the MNO CNE or step 438, in which the MNO CNE 306 determines that UE subscriber data is available in the MNO CNE.

If the determination of step 434 is that subscriber data is not available in the MNO CNE, then operation proceeds from step 438 to step 440. In step 440, the MNO CNE 306 is operated to obtain UE subscription data corresponding to UE 302 from the UE's home network. Step 440 includes steps 442 and 452. In step 442 MNO CNE 306 generates and sends a Get Subscriber Data message 444, including UE identity information SUCI+GUTI, corresponding to UE 302, to first MSO CNE 308, which receives the message 444 in step 446, recovers the communication information, identifies UE 302 and accesses or retrieves the stored UE 302 subscriber data. In step 448, first MSO CNE 308 generates and sends Set Subscriber Data message 450 to MNO CNE 306, said message 450 including the UE identity information SUCI+GUTI, corresponding to UE 302, and the subscriber data corresponding to UE 302. In step 452, MNO CNE 306 receives message 450 and recovers the communicated information. Operation proceeds from step 452 of FIG. 5A to FIG. 5B. Returning to step 434, alternatively, if the determination of step 434 is that subscriber data is already available in the MNO CNE, then operation proceeds from step 436 of FIG. 5A to FIG. 5B.

Box 454 of FIG. 5B indicates that UE 302 remains at the selected network and the GUTI (attach accept message) contains the operator ID. In step 456 the MNO CNE 306 responds to the UE with the location/routing area identities with operator's ID. Step 456 includes step 458. In step 458 MNO CNE 306 generates and sends location update accept message 460 to RAN 304, said message 460 including UE ID information, PLMN-ID, LAI, RAI. In step 462, RAN 304 receives the location update accept message 460 and recovers the communicated information. In step 464, RAN 304 generates and sends location update accept message 466 to UE 302, said message 466 including UE ID information, PLMN-ID, LAI, RAI. Location update accept message 466 is a forwarded copy of received location update accept message 460. In step 468 UE 302 receives the location update accept message and recovers the communicated information. In response to receiving the location update accept message 466 in step 468, UE 302, in step 470 is operated to register with the MSO. In steps 472 and 474, the UE 302 and the first MSO CNE 308 are operated, respectively, to send and receive registration signals 476. The UE 302 is operated to display, to the user of UE 302, the registered MSO PLMN ID or operator name corresponding to the registered MSO PLMN ID, as indicated in information box 478.

Operation proceeds from FIG. 5B to FIG. 5C. Information block 480 indicates that UE 302 is idle for MNO core and UE is a MSO core subscriber. Information block 482 indicates the RAN 304 is a wireless radio access network of MNO, e.g., RAN 304 is one or MNO's gNBs. Information block 484 indicates that MNO CNE 306 is a hosting operator's CNE, e.g., a MNO core node which serves RAN 304. Information block 486 indicates that MSO CNE 310 is a second MSO core node which is part of the MSO's core network of the operator to which UE 302 is a subscriber. Information block 488 indicates that first MSO CNE 308 is a MSO home core node with UE subscription information.

In step 490 UE 302 initiates connection establishment via MNO CNE 306. In step 492, UE 302 generates and sends RRC connection request message 494 to RAN 304, which receives the RRC connection request 494 in step 496. In step 498, RAN 304 generates and sends RRC connection setup message 500 to UE 302, which receives message 500 in step 502. In step 504, UE 302 generates and sends RRC connection setup complete message 506 to RAN 304, which receives message 506 in step 508.

In step 510 UE 302 generates and sends initiate direct transfer message 512 to RAN 304. In step 512, RAN 304 receives the initiate direct transfer message 512 in step 514. In step 516 RAN 304 generates and sends initiate direct transfer message 518 to MNO CNE 306. In step 522 MNO CNE 306 generates and sends identity request message 524 to UE 302, which receives the identity request 524 in step 526. In response to the received identity request, in step 528, UE 302 generates and sends identity response message 530 to MNO CNE 306. In step 532 the MNO CNE 306 receives the identity response message 530 and recovers the communicated information, e.g., UE 302 ID information.

In step 533 the MNO CNE 306 determines that the MNO wants to start a new UE interwork with the MSO core. In step 534, the MNO CNE 306 generates and sends an init_UE message 536 to first MSO CNE 538, said init_UE message 536 including a command=attach request, a UE 302 ID, a flag=redirect request, an ECGI (EUTRA Cell Global Identifier) and a TAI (Tracking Area Identifier). In step 538 the first MNO CNE 308 receives the init_UE message 536 and recovers the communicated information.

In steps 540 and 542, the UE 302 and first MSO CNE 308 are operated, respectively, to communication, e.g., send/receive, authentication/authorization request/response signaling 544 using encryption with RAN 304 and MNO CNE 306 acting as proxies.

In step 546 the first MSO CNE 308 is operated to access/download subscriber data relating to UE (302) identified by SUCI+GUTI, and core hosting PLMN-ID (MNO PLMN-ID).

In some embodiments optional step 5461 is performed, while in other embodiments, optional steps 5461 is bypassed. In step 5461 the MNO CNE 306, which has configuration information about alternative MSO core nodes, which may be selected for interworking, selects a MSO core node, e.g., MNO CNE 306 selects a second MSO core node, which is second MSO CNE 310, from among the alternative MSO core nodes.

In step 5462 MNO CNE 306 generates and sends a MSO core node selection message 5463 to first MSO CNE 308. The MSO core node selection message 5463 may, and sometimes does include information indicating a MNO selected core node to be used for interworking. For example, if optional step 5461 is performed, the generated MSO core selection message 5463 includes information indicating the MSO core node of the MNO CNE selection of step 5461. However, if optional step 5461 is not performed, the generated MSO core selection message 5463 does not include information indicating a MNO selected MSO core node to be used for interworking, e.g., with the selection being left up entirely to the first MSO CNE 308. In step 5464 first MSO CNE 308 receives the MSO core node selection information and recovers and processes the received information communicated in the message 5463. In step 5465 the first MSO CNE 308 determines if the received selection message 5463 includes information indicating a selected MSO core node. Each iteration of step 5463 includes one of step 5466, in which the first MSO CNE 308 determines information indicating the MNO selected MSO core node is included in message 5463, or step 5467, in which the first MSO CNE 308 determines information indicating the MNO selected MSO core node is not included in message 5463. Operation proceeds from step 5466 to step 5468, in which the first MSO CNE 308 identifies the MNO selected MSO core node, which is recommended to be used for interworking. Operation proceeds from step 5467 or from step 5468 to step 5469. In step 5469 the first MSO CNE 308 retrieves MSO service agreements with the MNO. In some embodiments, in which the MNO CNE 306 selected and communicated a MSO core node, e.g., a recommended MSO core to be used for interworking, operation proceeds from step 5469 to step 5470, in which the first MSO CNE 308 evaluates and approves or disapproves the MNO recommended selection. If the result of the evaluation is an approval, then the MNO recommended selection is selected by the first MSO CNE 308 in step 548 of FIG. 4D. However, if the result of the evaluation is a disapproval, then the first MSO CNE 308 makes its own selection is step 548 of FIG. 4D. If a recommended selected MSO node was not included in message 5463, then operation proceeds from step 5469 to step 548 of FIG. 4D, in which the first MSO CNE 308 makes a selection of a MSO core node to use for interworking on its own, e.g., without having to process and consider a MNO recommendation.

In step 548, the first MSO CNE 308 selects a MSO core node, e.g., the first MSO core node selects second MSO CNE 310, e.g., from among a plurality of alternative MSO core nodes to interwork with MNO core based one or more or all of: a received recommended selection from the MNO CNE 306, service agreements between the MSO and MNO, capability information, e.g. indicating which core nodes are suitable to support interworking between cores, and/or location information, e.g. information indication which of the alternatives core node which are suitable for interworking is closest to the MNO CNE 306.

In step 549, the first MSO CNE 308 generates and sends UE subscriber data 5491 to second MSO CNE 310. In step 550 the first MSO CNE 308 commands the MNO CNE 306 to use a new route via the second MSO CNE 310 and informs the second MSO CNE 310. Step 550 includes steps 552 and 558. In step 552 the first MSO CNE 308 generates and sends reroute message 554 to second MSO CNE 310. Reroute message 554 includes command=inform and includes information identifying the MNO CNE 306 as the node with which the second MSO CNE 310 will have an interworking connection. In step 556 second MSO CNE 310 receives reroute message 554 and recovers the communicated information. In step 558 the first MSO CNE 308 generates and sends reroute message 560 to MNO CNE 306. Reroute message 560 includes command=re-direct and includes information identifying the second CNE 310 as the node with which the MNO CNE 306 will have an interworking connection. In step 556 second MSO CNE 310 receives reroute message 554 and recovers the communicated information.

In step 563 MNO CNE 306 determines that MNO wants to start a new UE interwork with MSO core. Operation proceeds from step 563 to step 564, in which the MNO CNE 306 defines UE 302 route policy with second CNE 310 based on UE 302 ID information, MSO PLMN-ID, LAI, RAI. Step 564 includes step 566, in which MNO CNE 306 generates and sends init_UE message 568 to second MSO CNE 310, said init_UE message 568 including a command=attach request, a UE 302 ID, a flag=redirect request, an ECGI and a TAI. In step 570 the second MNO CNE 310 receives the init_UE message 568 and recovers the communicated information.

Operation proceeds from step 570 to step 571 and step 572. In step 571 the second MSO CNE 310 is operated to establish a connection with the UE 302. In step 572 UE 302 re-establishes connection with the MSO core via re-directed second CNE 310. Information box 574 indicates that each time the UE 302 connects to a new MSO CNE, the AAA must be done newly. In steps 576 and 578, UE 302 and second MSO CNE 310, are operated, respectively, to perform authentication and authorization operations including communicating, e.g., sending and receiving, authentication and authorization request/response, signals 580 using encryption with RAN 304 and MNO CNE 306 acting as proxies. In step 582 the second MSO CNE 310 generates and sends a reroute message 584 including information indicating command=complete, and information indicating status=accepted to MNO CNE 306. In step 586 the MNO CNE 306 receives the reroute message 584 indicating complete and accepted, and the MNO CNE 306 recovers the communicated information. In step 588, in response to the received message 584 indicating complete and accepted, the MNO CNE 306 generates and sends direct transfer message 590 including information status=accepted to UE 302 via RAN 304. In step 592, UE 302 receives the direct transfer message indicating status=accepted, and in response, in step 594, UE 302 generates and sends attach complete message 596 to second MSO CNE 310. In step 598 second CNE 310 receives the attach complete message 598 and recognizes that that attachment is complete. Information box 600 indicates that UE 302 is connected with the second MSO CNE 310 of the MSO core via the MNO network. There is an interworking connection between the MNO CNE 306 and the MNO CNE 306 which is being used; and the RAN 304 and the MNO CNE act as proxies.

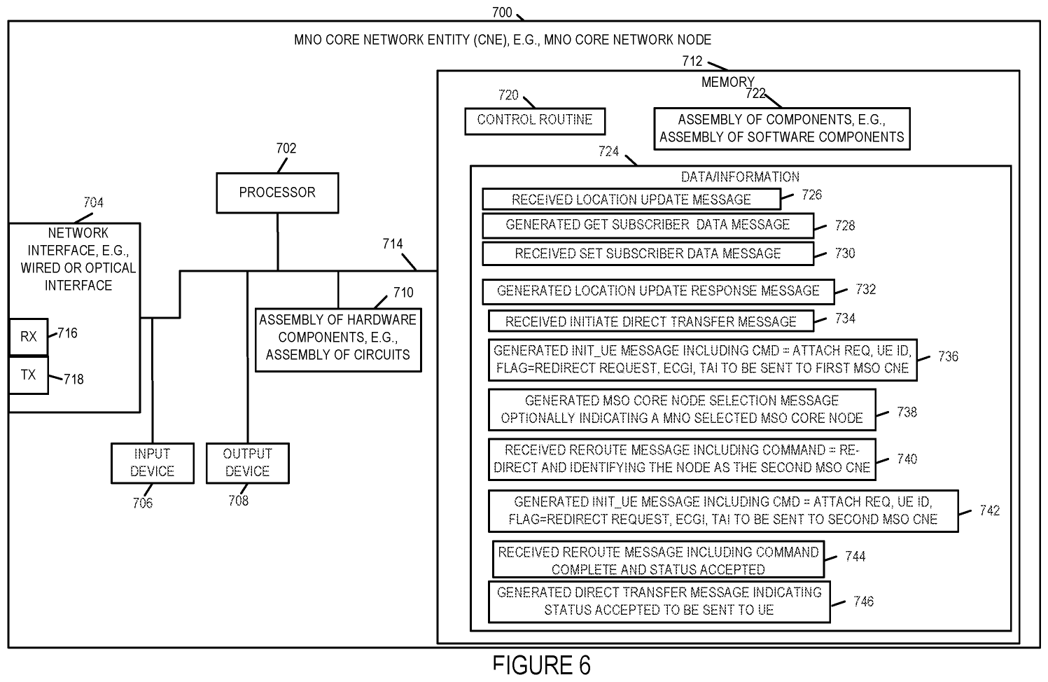

FIG. 6 is a drawing of an exemplary MNO core network entity (CNE) 700, e.g., a MNO core network node, in accordance with an exemplary embodiment. MNO core network entity (CNE) 700 is, e.g., MNO CNE 306 of system 300 of FIG. 4 and of signaling diagram 400 of FIG. 5, a MNO CNE within MNO N 5GC 118 of FIG. 2, a MNO CNE within MNO N1 core 222 of FIG. 3, or a MNO CNE within MNO N2 core 226 of FIG. 3.

MNO CNE 700 includes a processor 702, e.g., a CPU, a network interface 704, e.g., a wired or optical interface, an input device 706, e.g., a keyboard or mouse, an output device 708, e.g., a display, an assembly of hardware components 710, e.g., an assembly of circuits, and memory 712 coupled together via a bus 714 over which the various elements may interchange data and information.

Network interface 704 includes a receiver 716 and a transmitter 718. Memory 712 includes a control routine 720, an assembly of components 722, e.g., an assembly of software components, and data/information 724. Control routine 720 includes machine executable instructions, which when executed by processor 702 control the MNO CNE 700 to perform basic operations including read to memory, write to memory, operate an interface, etc. Assembly of software components 722 includes machine executable instructions, which when executed by processor 702 control the MNO CNE 700 to perform steps of an exemplary method in accordance with the present invention, e.g., steps of the method of signaling diagram 400 of FIG. 5 which are performed by MNO CNE 306.

Data/information 724 includes a received location update message 726 including the MSO PLMN-ID 726, a generated get subscriber data message 728, a received set subscriber data message 730, a generated location update response message 732, a received initiate direct transfer message 734, a generated init_UE message 736 including command=attach request, UE ID information, a flag indicating re-direct request, ECGI, and TAI, said message to be sent to a first MSO CNE (home MSO CNE for UE with UE subscriber data), a generated MSO core node selection message optionally including a MNO selected MSO core node 740, a received reroute message 740 including a command=redirect and information identifying the node to be redirected to as the second MSO CNE, a generated init_UE message 742 including command=attach request, UE ID information, a flag indicating re-direct request, ECGI, and TAI, said message to be sent to the second MSO CNE, a received reroute message 744 including command=complete and status accepted, and a generated direct transfer message indicating status accepted to be sent to UE 724.

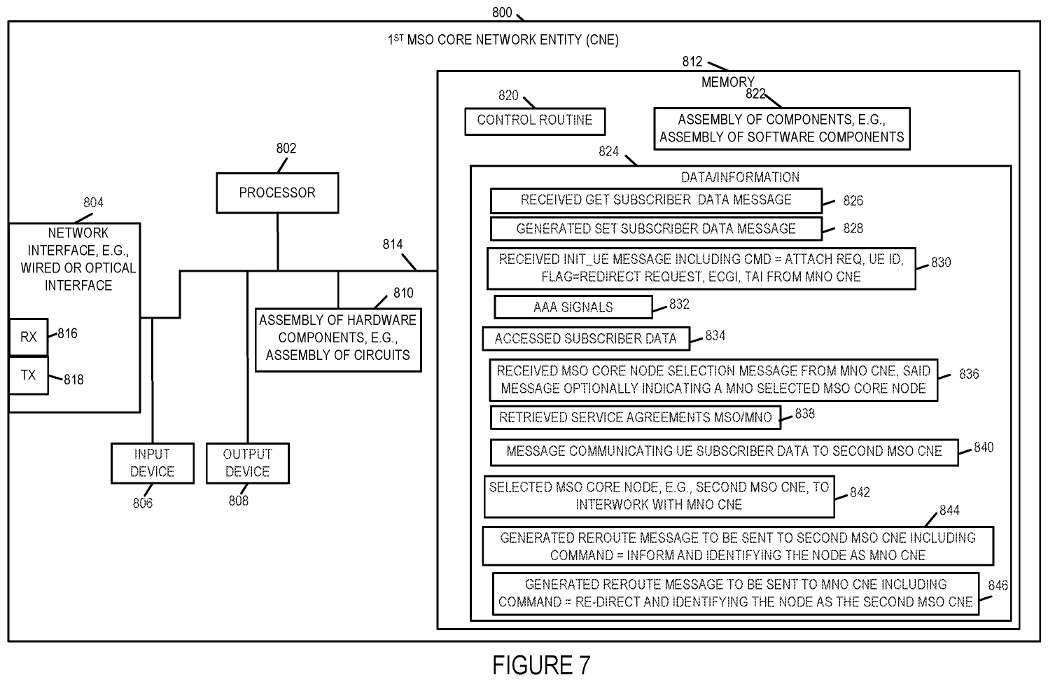

FIG. 7 is a drawing of an exemplary first MSO core network entity (CNE) 800, e.g., a first MSO core network node, in accordance with an exemplary embodiment. Exemplary first MSO CNE 800 is, e.g., first MSO CNE 308 of system 300 of FIG. 4 and of signaling diagram 400 of FIG. 5, a MSO CNE within MSO S 5GC 114 of FIG. 2, or a MSO CNE within MSO core 218 of FIG. 3.

First MSO CNE 800 includes a processor 802, e.g., a CPU, a network interface 804, e.g., a wired or optical interface, an input device 806, e.g., a keyboard or mouse, an output device 808, e.g., a display, an assembly of hardware components 810, e.g., an assembly of circuits, and memory 812 coupled together via a bus 814 over which the various elements may interchange data and information.

Network interface 804 includes a receiver 816 and a transmitter 818. Memory 812 includes a control routine 820, an assembly of components 822, e.g., an assembly of software components, and data/information 824. Control routine 820 includes machine executable instructions, which when executed by processor 802 control the first MSO CNE 800 to perform basic operations including read to memory, write to memory, operate an interface, etc. Assembly of software components 822 includes machine executable instructions, which when executed by processor 802 control the first MSO CNE 800 to perform steps of an exemplary method in accordance with the present invention, e.g., steps of the method of signaling diagram 400 of FIG. 5 which are performed by first MSO CNE 308.

Data/information 824 includes a received get subscriber data message 826, a generated set subscriber data message 828, a received initiate UE (init_UE) message 830 including command=attach request, UE ID information, flag=re-direct request, ECGI, TAI, said message being received from MNO CNE, AAA signals 832, accessed subscriber data 834, a received MSO core node selection message 836, from MNO CNE, said message 836 optionally indicating a MNO selected MSO core node, retrieved service agreements between the MSO and MNO 838, a message 840 communicating UE subscriber data to the second MSO CNE, a selected MSO core node, e.g., second MSO CNE, to interwork with MNO CNE 842, a generated reroute message 844 to be sent to second MSO CNE, said message including command=inform and including information identifying the node as the MNO CNE, and a generated reroute message 846 to be sent to MNO CNE, said message including command=re-direct and including information identifying the node as the second MSO CNE.

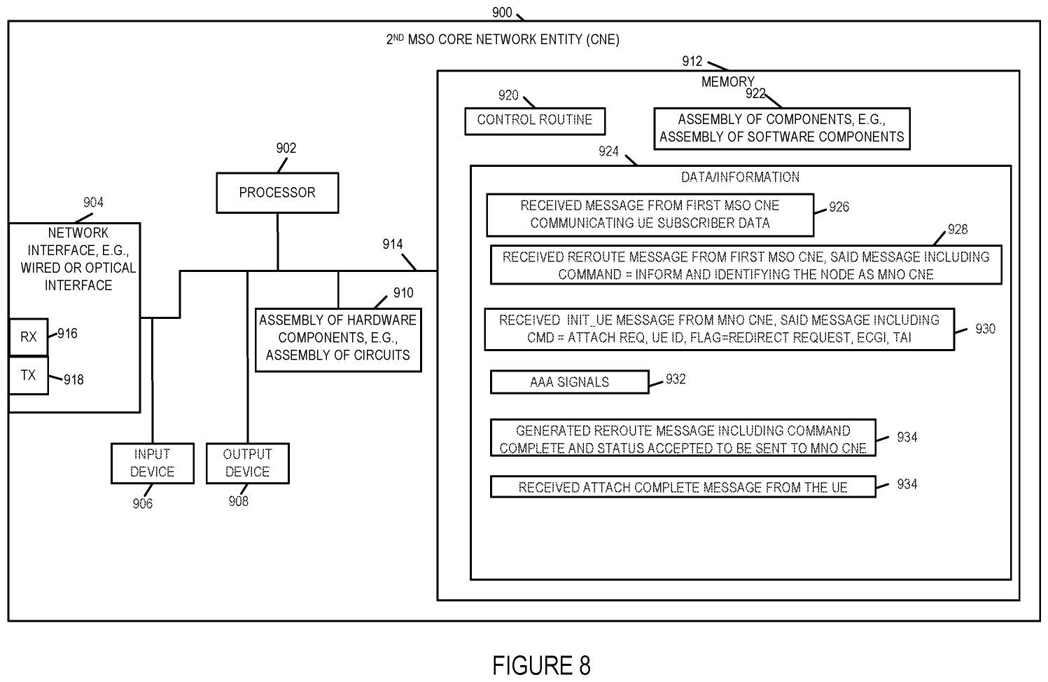

FIG. 8 is a drawing of an exemplary second MSO core network entity (CNE) 900, e.g., a second MSO core network node, in accordance with an exemplary embodiment. Exemplary second MSO CNE 900 is, e.g., second MSO CNE 310 of system 300 of FIG. 4 and of signaling diagram 400 of FIG. 5, a MSO CNE within MSO S 5GC 114 of FIG. 2, or a MSO CNE within MSO core 218 of FIG. 3.

Second MSO CNE 900 includes a processor 902, e.g., a CPU, a network interface 904, e.g., a wired or optical interface, an input device 906, e.g., a keyboard or mouse, an output device 908, e.g., a display, an assembly of hardware components 910, e.g., an assembly of circuits, and memory 912 coupled together via a bus 914 over which the various elements may interchange data and information.

Network interface 904 includes a receiver 916 and a transmitter 918. Memory 912 includes a control routine 920, an assembly of components 922, e.g., an assembly of software components, and data/information 924. Control routine 920 includes machine executable instructions, which when executed by processor 902 control the second MSO CNE 900 to perform basic operations including read to memory, write to memory, operate an interface, etc. Assembly of software components 922 includes machine executable instructions, which when executed by processor 902 control the second MSO CNE 900 to perform steps of an exemplary method in accordance with the present invention, e.g., steps of the method of signaling diagram 400 of FIG. 5 which are performed by second MSO CNE 310.

Data/information 924 includes a received message 926 from first MSO CNE, said message communicating UE subscriber data, a received reroute message 926 from first MSO CNE, said message including command=information and information identifying the node as MNO CNE, a received init_UE message 930 from MNO CNE, said message including command=attach request, UE ID information, flag=redirect request, ECGI, and TAI, AAA signals 932, a generated reroute message 934 to be sent to MNO CNE, said message including command=complete and including information indicating status=accepted, and a received attach complete message 936 from the UE.

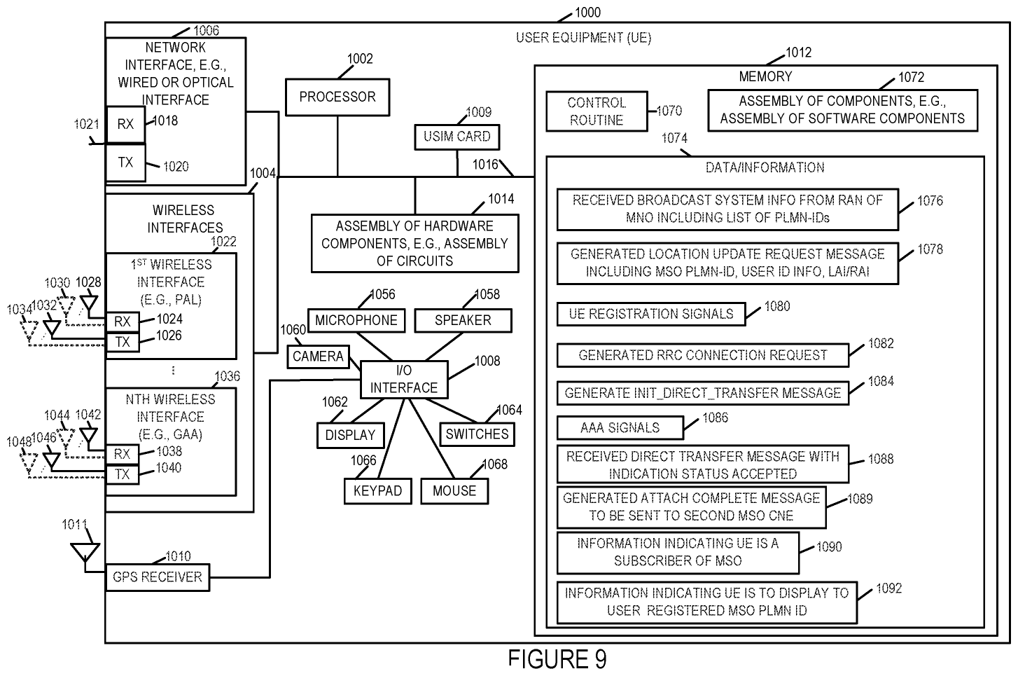

FIG. 9 is a drawing of an exemplary user equipment (UE) 1000 in accordance with an exemplary embodiment. Exemplary UE 1000 is, e.g., UE 302 of system 300 of FIG. 4 and of signaling diagram 400 of FIG. 5, UE 102 of FIG. 2, or UE 214 of FIG. 3.

Exemplary UE 1000 includes a processor 1002, e.g., a CPU, wireless interfaces 1004, network interface 1006, I/O interface 1008, USIM card 1009, GPS receiver 1010, memory 1012, and assembly of hardware components 1014, e.g., an assembly of circuits, coupled together via a bus 1016 over which the various elements may interchange data and information. Wireless interfaces 1004 include a plurality of wireless interfaces (1st wireless interface 1022, . . . . Nth wireless interface 1036). 1st wireless interface 1022 includes wireless receiver 1024 and wireless transmitter 1026. Wireless receiver 1024 is coupled to one or more receive antennas or receive antenna elements (1028, . . . , 1030) via which the wireless receiver 1024 receives wireless signals, e.g., from a RAN, e.g., a gNB base station, or from a wireless AP, e.g., a WiFi AP. Wireless transmitter 1326 is coupled to one or more transmit antennas or transmit antenna elements (1032, . . . , 1034) via which the wireless transmitter 1026 transmits wireless signals, e.g., to a RAN, e.g., a gNB base station or to a wireless AP, e.g., a WiFi AP. Nth wireless interface 1036 includes wireless receiver 1038 and wireless transmitter 1040. Wireless receiver 1038 is coupled to one or more receive antennas or receive antenna elements (1042, . . . , 1044) via which the wireless receiver 1038 receives wireless signals, e.g., from a RAN, e.g., a gNB base station or from a wireless AP, e.g., a WiFi AP. Wireless transmitter 1040 is coupled to one or more transmit antennas or transmit antenna elements (1046, . . . , 1048) via which the wireless transmitter 1040 transmits wireless signals, e.g., to a RAN, e.g., a gNB base station, or to a wireless AP, e.g., a WiFi AP. Network interface 1006 includes receiver 1018, transmitter 1020 and connector 1021. Network interface 1006 may be, and sometimes is, used by UE 1000 when the UE 1000 is stationary and located at a site where a wired or optical connection is available. GPS receiver 1010 is coupled to GPS antenna 1011, via which the UE 1000 receives GPS signals. The GPS receiver 1010 processes the received GPS signals to determine time, UE 1000 position, e.g., latitude, longitude and altitude, UE velocity information, and/or UE navigation information.

UE 1000 further includes a plurality of I/O devices (microphone 1056, speaker 1058, camera 1060, display 1062, e.g., a touch screen display, switches 1064, keypad 1066 and mouse 1068, coupled to I/O interface 1008 via which the various I/O devices may communicate with other elements within UE 1000.

Memory 1012 includes control routine 1070, assembly of components 1072, e.g., an assembly of software components, and data/information 1074. Control routine 1070 includes machine executable instructions, which when executed by processor 1002 control the UE 1000 to perform basic operations including read to memory, write to memory, operate an interface, etc. Assembly of software components 1072 includes machine executable instructions, which when executed by processor 1002 control the UE 1000 to perform steps of an exemplary method in accordance with the present invention, e.g., steps of the method of signaling diagram 400 of FIG. 5, which are performed by UE 302.

Data/information 1074 includes received broadcast system information from RAN of MNO including list of PLMN-IDs 1076, generated location update request message including MSO PLMN-ID, user ID info, LAI/RAI 1078, UE registration signals 1080, a generated RRC connection request 1082, a generated initiate direct transfer message 1084, AAA signals 1086, a received direct transfer message with indication status accepted 1088, a generated attach complete message to be sent to the second MSO CNE 1089, information indicating UE is a subscriber of MSO 1090, and information indicating UE is to display to UE user the registered MSO PLMN-ID or the operator name corresponding to MSO PLMN-ID 1092.

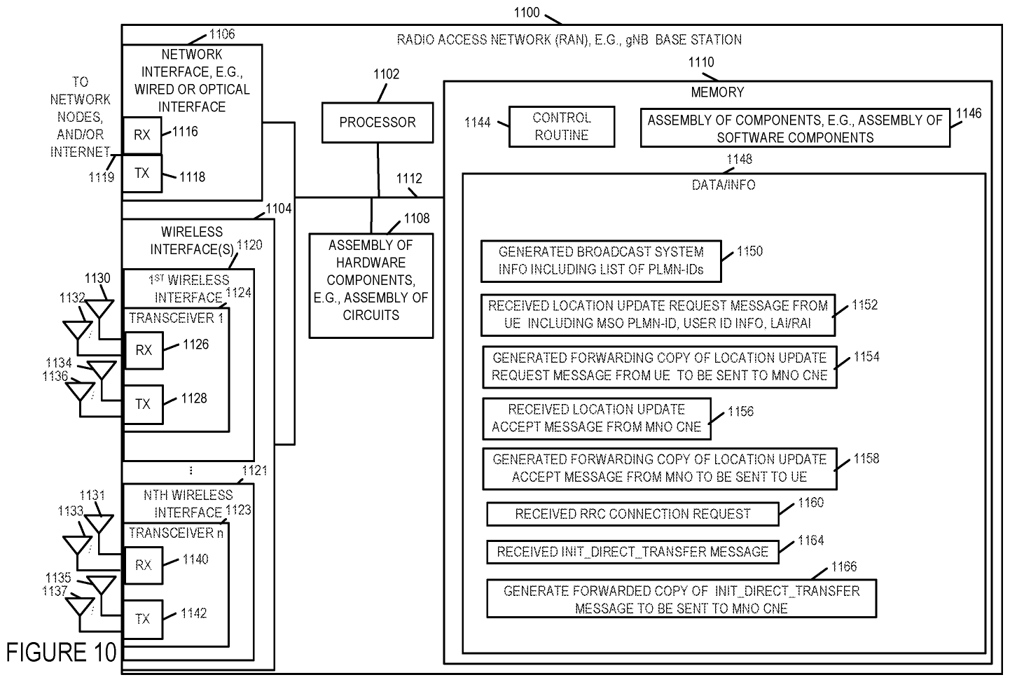

FIG. 10 is a drawing of an exemplary radio access network (RAN) 1100, e.g., a MNO gNB base station, in accordance with an exemplary embodiment. Exemplary RAN 1100 is, e.g., RAN 304, e.g., a gNB base station, of system 300 of FIG. 3 and of signaling diagram 400 of FIG. 5, RAN 116 of FIG. 2, RAN 220 of FIG. 3, or RAN 224 of FIG. 3. RAN 1100 includes a processor 1102, e.g., a CPU, wireless interfaces 1104, a network interface 1106, e.g., a wired or optical interface, an assembly of hardware components 1108, e.g., an assembly of circuits, and memory 1110 coupled together via a bus 1112 over which the various elements may interchange data and information.

Wireless interfaces 1104 includes a plurality of wireless interfaces (wireless interface 1 1120, . . . , wireless interface n 1121. Wireless interface 1 1120 includes transceiver 1 1124 which includes wireless receiver 1126 and wireless transmitter 1128. Wireless receiver 1126 is coupled to a plurality of receive antennas or receive antenna elements (1130, . . . , 1132) via which the wireless receiver 1126 receives wireless signals, e.g., from UEs being served by the RAN 1100. Wireless transmitter 1128 is coupled to a plurality of transmit antennas or transmit antenna elements (1134, . . . , 1136) via which the wireless transmitter 1128 transmits wireless signals, e.g., to UEs being served by the RAN 1100. Wireless interface n 1122 includes transceiver n 1123 which includes wireless receiver 1140 and wireless transmitter 1142. Wireless receiver 1140 is coupled to a plurality of receive antennas or receive antenna elements (1131, . . . , 1133) via which the wireless receiver 1140 receives wireless signals, e.g., from UEs being served by the RAN 1100. Wireless transmitter 1142 is coupled to a plurality of transmit antennas or transmit antenna elements (1135, . . . , 1137) via which the wireless transmitter 1142 transmits wireless signals, e.g., to UEs being served by the RAN 1100.

Memory 1110 includes control routine 1144, assembly of components 1146, e.g., an assembly of software components, and data/information 1148. Control routine 1144 includes machine executable instructions, which when executed by processor 1102 control the RAN 1100 to perform basic operations including read to memory, write to memory, operate an interface, etc. Assembly of software components 1144 includes machine executable instructions, which when executed by processor 1102 controls the RAN 1100 to perform steps of an exemplary method in accordance with the present invention, e.g., steps of the method of signaling diagram 400 of FIG. 5 which are performed by RAN 304, e.g., a MNO gNB base station.

Data/information 1148 includes generated broadcast system information including a list of PLMN-IDs 1150, a received location update request message from UE including MSO PLMN-ID, user ID, LAI.RAI 1152, a generated forwarding copy of the location update request message from the UE to be sent to MNO CNE 1154, a received location update accept message from the MNO CNE 1156, a generated forwarding copy of the location update accept message from the MNO CNE to be sent to UE 1158, a received RRC connection request from UE 1160, a received initiate direct transfer message 1164 and a generated forwarded copy of the initiate direct transfer message to be sent to MNO CNE 1166.

Various aspects and/or features of some embodiments of the present invention are further discussed below. The MSO and MNO replace the links between 5GC or MSO and RAN of MNO with an interworking link among 5GCs from MSO and MNO (or among 5GC and EPC). UE always displays the subscriber's core operator, and the user experience is that there is only his subscription operator serving even though the network (RAN, Core) is supported by other operators. RAN and core of MNO are proxy nodes to handle UE connection, subscription configuration and AAA, which are now completed within MSO core node and no longer in the MNO. Although it is possible to have the mechanisms implemented in MNO nodes alike in roaming and existing MOCN, the invention localizes the service access in MSO so that MNO is purely a tunnel (layer 3).

When RAN (radio access network) broadcasts system information block-1 (SIB-1), the SIB-1 includes each of the available core network operators' PLMN-IDs. A MSO, which is the UE's subscriber's operator, has a network sharing service agreement with a MNO (who provides radio coverage). The agreement requests the MNO to include the MSO in the available core operator list sent in SIB-1 (when AMF sends priority PLMN list to UE). UE USIM profile is pre-configured to select the MSO (as the highest priority); this is configured to each of the USIMs prior to the sale by the MSO.

Thus, the UE is ensured to always select the MSO from available core network operators, provided the signal quality is supported by MNO operator's RAN/core, and the quality is above the QoS threshold for selection permission.

The UE always displays the MSO name as the serving operator, even though the MNO is from another operator. The UE never changes its selected core network operator before there is a connection set up.

The MNO core node triggers MSO home core node of UE for subscriber data, and the corresponding serving core node is selected based on the configuration. There are two options.

In a first option, the MNO core has configuration about alternative of MSO core nodes, and the MNO core node selects one of the alternative MSO core nodes and informs the MSO home core node of the MNO selected MSO core node in a core node selection message which is sent from the MNO core node to the MSO home core node. In a second option, the MNO core node sends a core node selection message to the MSO home core node without including a selected MSO core node in the core node selection message. The MSO home core node notices that the selection message does not include a selected MSO core node, and the MSO home core node retrieves its configuration of service agreements including information identifying alternative MSO core nodes that are associated with and can be used with the MNO core node, and the MSO home core node a serving MSO core node to interwork with the MNO core node.

The MSO home core node can re-select the MSO core node, when the selected node by the MNO does not correspond to the MSO's topology or service logics.

The MSO home core node informs MNO core about the selected serving core node form MSO for a UE to connect with. It is assumed that the MNO core is configured already with each of the alternative MSO core nodes. This configuration should have happened during network planning. The link is set up between MNO core and MSO core uses the configuration.

When MNO core is informed about the selected MSO core node, the MNO core node starts to route all signaling and traffic from the UE to the selected MSO core node.

Before each time the UE starts to connect with the core via the RAN, namely after each init_UE has been done from MNO to MSO, there is a new authentication, authorization and accounting to be executed.

To protect the UE subscriber and user plane data, each of the control plane messages and user plane traffic are encrypted between UE and MSO core node, after UE_init has completed; this means that the MNO networks should not be able to intercept the contents.

Various benefits of the present invention are described below.

If an operator, acting alone, were to try to provide universal service and coverage for the states, it would be costly. There are cost saving factors to using MOCN (network sharing between multi-operators). One carrier may cover a specialized technology (e.g., wireline to residential and business offices). Different carriers may correspond to different technologies, different frequencies, and/or different regions. Some carriers may provide coverage to outside areas, e.g., streets, stadiums and parks, while other carriers may provide coverage to indoor areas. One carrier may cover a particular set of: state, city and county, while another carrier may cover another set of: state, city and county.

Agreements, in accordance with the present invention including interworking connections between MNO and MSO cores, between operators (e.g., MSOs and MNOs) to work together can provide their subscribers with a high level of user experience, e.g., wide coverage, good signal quality, high data throughput, minimal amounts of connection loss, etc. Also, in accordance with the present invention, the user will not notice that its service is being carried out by the multiple operators (MSO and MNOs) working together, and the MSO to which the user subscribes will be viewed by the user as providing outstanding overall service. The approach of the current invention, in which the cores of both MNO and MSO work together provides for improved QoS over the approach in which the MSO core communicates directly to the RAN of the MNO via a connection, since the MNO core knows how to tune up the MNO RAN, while the MSO core does not have the same level of knowledge with regard to fine tuning the MNO RAN. The approach of the current invention results in reduced CAPEX when utilizing each of the different operator's allocated spectrums in different parts of the coverage area. The approach of the current invention results in reduced OPEX (operating expenses) when the MSO focuses on service logics and the MNO specializes in network connectivity.

The approach of the current invention results in the following advantages for an operator, e.g., a MSO operator. The number of links is reduced over the approach in which the MSO core connects directly to MNO RANs. The 5GC or the MSO does not need to deploy and OAM directly RAN nodes of the MNO; this can reduce lots of coordination which would otherwise be required between operators. The policy control and signaling between MNO 5GC and RAN can be utilized by the MSO, and there is no need to implement the same level of protocol to control it from MSO 5GC.

A service benefit from the implementation of the current invention is that a customer can obtain connectivity service differentiated with QoS when MSO core supports the best selection of an MNO network which can meet the UE QOS requirements.

On main architecture difference between the approach of the current invention and prior art approaches is that with the approach of the current invention a participating operator (e.g., a MSO) interacts with a hosting core (e.g., a MNO core), while in the prior art approach a participating operator (e.g., a MSO) interacts with a hosting RAN (e.g., a MNO RAN). On main interface difference between the approach of the current invention and prior art approaches is that with the approach of the current invention a participating operator the hosting operator core (e.g., MNO core) is an intermediate node between the hosting RAN (e.g., MNO RAN) and the participating core (e.g., MSO core), while in the prior art approach there is no involvement of the hosting core (MNO core).

Procedural aspects in accordance with some embodiments of the present invention, will now be described. Whenever a MNO core wants to start a new UE interwork with MSO core, the MNO core sends init_UE message to the MSO core. The init_UE message includes the following parameters: i) command type: attach-request indicates that UE is asking for network connection and asks MSO core to authenticate/authorize the UE; ii) UE identification: caller number, e.g., GUTI, IMSI, SUPI/SUCI; iii) flag: when it's the first time to the MSO then the flag is set (to indicate) re-direct request, when it is not the first try then the flag is set (to indicate) re-establishment; iv) ECGI: cell identification, e.g., MCC, MNC, gNB-Id, cell-Id; v) TAI: tracking area identification, e.g., MCC, MNC, tracking area code.

In various embodiments, in accordance with the present invention, are based on a MOCN architecture; however, with the deletion of direct link between MNO RANs and MSO core (used in some prior art approaches), and with included novel added core node inter-connections, e.g., MSO core node to MNO core node inter-connections, in accordance with the approach of the present invention.

A feature of some embodiments of the present invention is that an MNO core node is used as a proxy node to interwork across RAN and MSO core.

In some embodiments, in accordance with the present invention, MSO runs over MNO's network and whether MNO implements virtualization is optional.

In some embodiments, in accordance with the present invention, the UE is using one SIM from home PLMN; MNO RAN is shared with the MSO based on service/business agreement, and single SIM is supported.

### Numbered List of Exemplary Method Embodiments

Method Embodiment 1. A communications method, the method comprising: operating a mobile network operator (MNO) core network entity (306) to initiate (534) a user equipment (UE) interworking operation with a multiple system operator (MSO) core network by sending an initiate message (536) (INT_UE message) communicating an attach request corresponding to a first UE (302) to a first MSO core network entity (node 308) which has access to first UE subscription data; and receiving (562) at the at the MNO core network entity (306) a message (560) including a command (e.g., receive a reroute message 560 including a re-direct command) from the first MSO core network entity (308), said command commanding the MNO core network entity (306) to use a second MSO core network entity (310), which is an MSO network interworking entity, as the source for UE policy information (e.g., route policy information) to be applied to service (e.g., communication service) provided to the first UE (302) (e.g., by one or more nodes of the MNO network).

Method Embodiment 1A. The method of Method Embodiment 1, wherein the first MSO core entity (node 308) stores subscription data corresponding to the first UE or has access to stored subscription data corresponding to the first UE.

Method Embodiment 1B. The method of Method Embodiment 1A, wherein the first MSO core network entity (308) serves as a home subscription data service provider when the first UE (302) is in the MSO network (e.g., attached to a landline (cable or fiber) AN, an access point AP or other RAN in the MSO network).

Method Embodiment 2. The method of Method Embodiment 1, further comprising: receiving (520), at MNO core network entity (306), prior to operating the MNO core network entity (306) to initiate (534) the UE interworking operation with the MSO core network, a message (such as complete init_direct_transfer message 518) relating to first UE connection establishment at a radio access node (RAN) 304 in the MNO network (e.g. of a MNO operator who has a service agreement with the mobile service operator (MSO) which operates a MSO network including an MSO network core which includes at least a first MSO core network entity (node 308) which has access to first UE service subscription data and a second MSO core network entity (310) which is an MSO network interworking entity).

Method Embodiment 3. The method of Method Embodiment 1, further comprising: operating (548) the first MSO core network entity (308) to select from a plurality of interworking nodes in the MSO network the second MSO core network entity (310) to serve as the interworking node for communication services provided to the first UE (302) while the first UE (302) is communicating via a RAN (304) in the MNO network.

Method Embodiment 3A. The method of Method Embodiment 3, wherein selecting (548) from the plurality of interworking nodes in the MSO network includes selecting the second MSO core network entity (310) based on a service agreement between the MNO network and MSO network and which nodes in the MSO network are capable of supporting the service agreement.

Method Embodiment 3B. The method of Method Embodiment 3, wherein selecting (548) from the plurality of interworking nodes in the MSO network includes selecting a MSO network node capable of operating as an interworking node that supports the service agreement between the MSO network and the MNO network.

Method Embodiment 3C. The method of Method Embodiment 3B, wherein the geographic location of the first UE (302) or distance to the MNO core network entity (306) is taken into consideration when selecting from the plurality of interworking nodes, said selecting picking the interworking node in the MSO network which supports the service agreement between the MSO network and the MNO network and which has the shortest connection to the MNO core network entity (306).

Method Embodiment 4. The method of Method Embodiment 1, further comprising: operating the first MSO core network entity (308) to communicate (566) the attach request (in message init_UE 568) corresponding to the first UE (302) to the second MSO core network entity (310).

Method Embodiment 4A. The method of Method Embodiment 4, further comprising: communicating (549) (e.g., sending) UE subscription data (5491) from the first MSO core network entity (308) to the second MSO core network entity (310) (e.g., prior to operating the first MSO core network entity (308) to communicate (566) the attach request (in init_UE message 568) corresponding to the first UE (302) to the second MSO core network entity (310)).

Method Embodiment 4B. The method of Method Embodiment 4, wherein operating the first MSO core network entity (308) to communicate (566) the attach request (in init_UE message 568) corresponding to the first UE (302) to the second MSO core network entity (310) includes sending the attach request with a re-direct request flag to the second MSO entity (310) over a communications link between the first MSO core network entity (308) and the second MSO core network entity (310) (e.g., without involvement of, or communication of the message between the core network entities (306, 310), over a radio access node (304)).

Method Embodiment 5. The method of Method Embodiment 4, further comprising: operating the second MSO core network entity (310) to establish (571) an MSO network connection with the first UE (302) (which from the perspective of the first UE (302) is operating the first UE (302) to re-establish (572) a connection with the MSO core via the re-directed second CNE).

Method Embodiment 6. The method of Method Embodiment 4, wherein operating the second MSO core network entity (310) to establish (571) the MSO network connection with the first UE (302) includes: operating the second MSO network entity (310) to send (582) a reroute message (584) (e.g., reroute (CMD-complete, status=accepted)) indicating that the reroute of the connection from the MNO network to the second MSO core network entity (310) has been completed and accepted by the second MSO network entity (310).

Method Embodiment 7. The method of Method Embodiment 6, further comprising: operating the MNO core network entity (306) to communicate (588) a message (e.g., DIRECT_TRANSFER (STATUS=ACCEPTED) message 590) to the first UE (302) indicating acceptance of the first UE (302) by the second MSO network entity (310).

Method Embodiment 8. The method of Method Embodiment 6, wherein operating the second MSO core network entity (310) to establish (571) the MSO network connection with the first UE (302) further includes: operating the second MSO network entity (310) to receive (598) an attach complete message (596) from the first UE (302).

### Numbered List of Exemplary System Embodiments

System Embodiment 1. A communications system (300), the system (300) comprising: a mobile network operator (MNO) core network entity (306) including a first processor (702) configured to: operate the MNO core network entity (306) to initiate (534) a user equipment (UE) interworking operation with a multiple system operator (MSO) core network by sending an initiate message (536) (INT_UE message) communicating an attach request corresponding to a first UE (302) to a first MSO core network entity (node 308) which has access to first UE subscription data; and operate the MNO core network entity (306) to receive (562) a message (560) including a command (e.g., receive a reroute message 560 including a re-direct command) from the first MSO core network entity (308), said command commanding the MNO core network entity (306) to use a second MSO core network entity (310), which is an MSO network interworking entity, as the source for UE policy information (e.g., route policy information) to be applied to service (e.g., communication service) provided to the first UE (302) (e.g., by one or more nodes of the MNO network).

System Embodiment 1A. The communications system (300) of System Embodiment 1, wherein the first MSO core entity (node 308) includes stored subscription data corresponding to the first UE or has access to stored subscription data corresponding to the first UE.

System Embodiment 1B. The communications system (300) of System Embodiment 1A, wherein the first MSO core network entity (308) serves as a home subscription data service provider when the first UE (302) is in the MSO network (e.g., attached to a landline (cable or fiber) AN, an access point AP or other RAN in the MSO network).

System Embodiment 2. The communications system (300) of System Embodiment 1, wherein said first processor (302) is further configured to: operate the MNO core network entity (306) to receive (520), prior to operating the MNO core network entity (306) to initiate (534) the UE interworking operation with the MSO core network, a message (such as complete init_direct_transfer message 518) relating to first UE connection establishment at a radio access node (RAN) 304 in the MNO network (e.g. of a MNO operator who has a service agreement with the mobile service operator (MSO) which operates a MSO network including an MSO network core which includes at least a first MSO core network entity (node 308) which has access to first UE service subscription data and a second MSO core network entity (310) which is an MSO network interworking entity).

System Embodiment 3. The communications system of System Embodiment 1, further comprising said first MSO core network entity (308), said first MSO core network entity (308) including a second processor (802), said second processor (802) being configured to: operate (548) the first MSO core network entity (308) to select from a plurality of interworking nodes in the MSO network the second MSO core network entity (310) to serve as the interworking node for communication services provided to the first UE (302) while the first UE (302) is communicating via a RAN (304) in the MNO network.

System Embodiment 3A. The communications system (300) of System Embodiment 3, wherein said second processor (802) is further configured to operate the first MSO core network entity (308) to select the second MSO core network entity (310) based on a service agreement between the MNO network and MSO network and which nodes in the MSO network are capable of supporting the service agreement, as part of being configured to operate the first MSO core network entity (308) to select (548) from the plurality of interworking nodes in the MSO network.

System Embodiment 3B. The communications system (300) of System Embodiment 3, wherein said second processor (802) is further configured to operate the first MSO core network entity (308) to select a MSO network node capable of operating as an interworking node that supports the service agreement between the MSO network and the MNO network, as part of being configured to operate the first MSO core network entity (308) to select (548) from the plurality of interworking nodes in the MSO network.

System Embodiment 3C. The communications system (300) of System Embodiment 3B, wherein the geographic location of the first UE (302) or distance to the MNO core network entity (306) is taken into consideration when selecting from the plurality of interworking nodes, said selecting picking the interworking node in the MSO network which supports the service agreement between the MSO network and the MNO network and which has the shortest connection to the MNO core network entity (306).

System Embodiment 4. The communications system (300) of System Embodiment 1, further comprising said first MSO core network entity (308), said first MSO core network entity (308) including a second processor (802), said second processor (802) being configured to: operate the first MSO core network entity (308) to communicate (566) the attach request (in message init_UE 568) corresponding to the first UE (302) to the second MSO core network entity (310).

System Embodiment 4A. The communications system (300) of System Embodiment 4, wherein said second processor (802) is further configured to: operate the first MSO core network entity (308) to communicate (549) (e.g., send) UE subscription data (5491) from the first MSO core network entity (308) to the second MSO core network entity (310) (e.g., prior to operating the first MSO core network entity (308) to communicate (566) the attach request (in init_UE message 568) corresponding to the first UE (302) to the second MSO core network entity (310)).

System Embodiment 4B. The communications system (300) of System Embodiment 4, wherein said second processor (802) is configured to operate the first MSO core network entity (308) to: send the attach request with a re-direct request flag to the second MSO entity (310) over a communications link between the first MSO core network entity (308) and the second MSO core network entity (310) (e.g., without involvement of, or communication of the message between the core network entities (306, 310), over a radio access node (304)), as part of being configured to operate the first MSO core network entity (308) to communicate (566) the attach request (in init_UE message 568) corresponding to the first UE (302) to the second MSO core network entity (310).

System Embodiment 5. The communications system (300) of System Embodiment 4, further comprising: said second MSO core network entity (310 or 900) including a third processor (902) configured to operate the second MSO core network entity (310) to establish (571) an MSO network connection with the first UE (302) (which from the perspective of the first UE (302) is operating the first UE (302) to re-establish (572) a connection with the MSO core via the re-directed second CNE).

System Embodiment 6. The communications system (300) of System Embodiment 4, wherein third processor (902) is configured to: operate the second MSO network entity (310) to send (582) a reroute message (584) (e.g., reroute (CMD=complete, status=accepted)) indicating that the reroute of the connection from the MNO network to the second MSO core network entity (310) has been completed and accepted by the second MSO network entity (310), as part of being configured to operate the second MSO core network entity (310) to establish (571) the MSO network connection with the first UE (302).

System Embodiment 7. The communications system (300) of System Embodiment 6, wherein said first processor (702) is further configured to: operate the MNO core network entity (306) to communicate (588) a message (e.g., DIRECT_TRANSFER (STATUS=ACCEPTED) message 590) to the first UE (302) indicating acceptance of the first UE (302) by the second MSO network entity (310).

System Embodiment 8. The communications system (300) of System Embodiment 6, wherein the third processor (902) is configured to: operate the second MSO network entity (310) to receive (598) an attach complete message (596) from the first UE (302), as part of being configured to operate the second MSO core network entity (310) to establish (571) the MSO network connection with the first UE (302).

### Numbered List of Exemplary Non-Transitory Computer Readable Medium Embodiments

Non-Transitory Computer Readable Medium Embodiment 1. A non-transitory computer readable medium (712) including machine executable instructions, which when executed by a processor (702) of a mobile network operator (MNO) core network entity (306) control the MNO core network entity (306) to: initiate (534) a user equipment (UE) interworking operation with a multiple system operator (MSO) core network by sending an initiate message (536) (INT_UE message) communicating an attach request corresponding to a first UE (302) to a first MSO core network entity (node 308) which has access to first UE subscription data; and receive (562) at the at the MNO core network entity (306) a message (560) including a command (e.g., receive a reroute message 560 including a re-direct command) from the first MSO core network entity (308), said command commanding the MNO core network entity (306) to use a second MSO core network entity (310), which is an MSO network interworking entity, as the source for UE policy information (e.g., route policy information) to be applied to service (e.g., communication service) provided to the first UE (302) (e.g., by one or more nodes of the MNO network).

Non-Transitory Computer Readable Medium Embodiment 2. A non-transitory computer readable medium (812) including machine executable instructions, which when executed by a processor (802) of a first multiple system operator (MSO) core network entity (308) control the first MSO core network entity (308) to: operate (548) the first MSO core network entity (308) to select, from a plurality of interworking nodes in the MSO network, a second MSO core network entity (310) to serve as the interworking node for communication services provided to the first UE (302) while the first UE (302) is communicating via a RAN (304) in the MNO network.

The techniques of various embodiments may be implemented using software, hardware and/or a combination of software and hardware. Various embodiments are directed to apparatus, e.g., RANs, e.g., gNB base station, access nodes, APs, user equipment (UE) devices, core network devices including MSO core network entities, e.g., MSO core nodes, and MNO core network entities, e.g., MNO core nodes. Various embodiments are also directed to methods, e.g., method of controlling and/or operating RANs, e.g., gNB base stations, access nodes, APs, user equipment (UE) devices, core network devices including MSO core network entities, e.g., MSO core nodes, and MNO core network entities, e.g., MNO core nodes, base stations, access points, user equipment (UE) devices, wireless devices including various UE devices such as, mobile devices, smartphones, subscriber devices, desktop computers, printers, IPTV, laptops, tablets, network edge devices. Various embodiments are also directed to a machine, e.g., computer, readable medium, e.g., ROM, RAM, CDs, hard discs, etc., which include machine readable instructions for controlling a machine to implement one or more steps of a method, e.g., any one of the methods described herein. The computer readable medium is, e.g., non-transitory computer readable medium. It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., RANs, e.g., gNB base station, access nodes, APs, user equipment (UE) devices, core network devices including MSO core network entities, e.g., MSO core nodes, and MNO core network entities, e.g., MNO core nodes, base stations, access points, user equipment (UE) devices, described herein are implemented using one or more components to perform the steps corresponding to one or more methods. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., RANs, e.g., gNB base station, access nodes, APs, user equipment (UE) devices, core network devices including MSO core network entities, e.g., MSO core nodes, and MNO core network entities, e.g., MNO core nodes, user (UE) devices, base stations, access points, core network devices, etc., include a processor configured to control the device to perform steps in accordance with one of the methods described herein.

The configuration of the processor may be achieved by using one or more components, e.g., software components, to control processor configuration and/or by including hardware in the processor, e.g., hardware components, to perform the recited steps and/or control processor configuration.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, for example, a RAN, e.g., gNB base station, an access node, an AP, a user equipment (UE) device, a core network device including a MSO core network entity, e.g., MSO core node, and MNO core network entity, e.g., a MNO core node, but could be in other devices as well. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method, the method comprising:
operating a mobile network operator (MNO) core network entity to initiate a user equipment (UE) interworking operation with a multiple system operator (MSO) core network by sending an initiate message communicating an attach request corresponding to a first UE to a first MSO core network entity which has access to first UE subscription data; and
receiving at the at the MNO core network entity a message including a command from the first MSO core network entity, said command commanding the MNO core network entity to use a second MSO core network entity, which is an MSO network interworking entity, as the source for UE policy information to be applied to service provided to the first UE.

2. The method of claim 1, wherein the first MSO core entity stores subscription data corresponding to the first UE or has access to stored subscription data corresponding to the first UE.

3. The method of claim 2, wherein the first MSO core network entity serves as a home subscription data service provider when the first UE is in the MSO network.

4. The method of claim 1, further comprising:
receiving, at MNO core network entity, prior to operating the MNO core network entity to initiate the UE interworking operation with the MSO core network, a message relating to first UE connection establishment at a radio access node (RAN) in the MNO network.

5. The method of claim 1, further comprising:
operating the first MSO core network entity to select from a plurality of interworking nodes in the MSO network the second MSO core network entity to serve as the interworking node for communication services provided to the first UE while the first UE is communicating via a RAN in the MNO network.

6. The method of claim 1, further comprising:
operating the first MSO core network entity to communicate the attach request corresponding to the first UE to the second MSO core network entity.

7. The method of claim 6, further comprising:
operating the second MSO core network entity to establish an MSO network connection with the first UE.

8. The method of claim 6, wherein operating the second MSO core network entity to establish the MSO network connection with the first UE includes:
operating the second MSO network entity to send a reroute message indicating that the reroute of the connection from the MNO network to the second MSO core network entity has been completed and accepted by the second MSO network entity.

9. The method of claim 8, further comprising:
operating the MNO core network entity to communicate a message to the first UE indicating acceptance of the first UE by the second MSO network entity.

10. The method of claim 8, wherein operating the second MSO core network entity to establish the MSO network connection with the first UE further includes:
operating the second MSO network entity to receive an attach complete message from the first UE.

11. A communications system, the system comprising:
a mobile network operator (MNO) core network entity including a first processor configured to:
operate the MNO core network entity to initiate a user equipment (UE) interworking operation with a multiple system operator (MSO) core network by sending an initiate message communicating an attach request corresponding to a first UE to a first MSO core network entity which has access to first UE subscription data; and
operate the MNO core network entity to receive a message including a command from the first MSO core network entity, said command commanding the MNO core network entity to use a second MSO core network entity, which is an MSO network interworking entity, as the source for UE policy information to be applied to service provided to the first UE.

12. The communications system of claim 11, wherein the first MSO core entity includes stored subscription data corresponding to the first UE or has access to stored subscription data corresponding to the first UE.

13. The communications system of claim 12, wherein the first MSO core network entity serves as a home subscription data service provider when the first UE is in the MSO network.

14. The communications system of claim 11, wherein said first processor is further configured to:
operate the MNO core network entity to receive, prior to operating the MNO core network entity to initiate the UE interworking operation with the MSO core network, a message relating to first UE connection establishment at a radio access node (RAN) in the MNO network.

15. The communications system of claim 11, further comprising said first MSO core network entity, said first MSO core network entity including a second processor, said second processor being configured to:
operate the first MSO core network entity to select from a plurality of interworking nodes in the MSO network the second MSO core network entity to serve as the interworking node for communication services provided to the first UE while the first UE is communicating via a RAN in the MNO network.

16. The communications system of claim 11, further comprising said first MSO core network entity, said first MSO core network entity including a second processor, said second processor being configured to:
operate the first MSO core network entity to communicate the attach request corresponding to the first UE to the second MSO core network entity.

17. The communications system of claim 16, further comprising:
said second MSO core network entity including a third processor configured to operate the second MSO core network entity to establish an MSO network connection with the first UE.

18. The communications system of claim 16, wherein third processor is configured to:
operate the second MSO network entity to send a reroute message indicating that the reroute of the connection from the MNO network to the second MSO core network entity has been completed and accepted by the second MSO network entity, as part of being configured to operate the second MSO core network entity to establish the MSO network connection with the first UE.

19. The communications system of claim 18, wherein said first processor is further configured to:
operate the MNO core network entity to communicate a message to the first UE indicating acceptance of the first UE by the second MSO network entity.

20. A non-transitory computer readable medium including machine executable instructions, which when executed by a processor of a mobile network operator (MNO) core network entity control the MNO core network entity to:
initiate a user equipment (UE) interworking operation with a multiple system operator (MSO) core network by sending an initiate message communicating an attach request corresponding to a first UE to a first MSO core network entity which has access to first UE subscription data; and
receive at the at the MNO core network entity a message including a command from the first MSO core network entity, said command commanding the MNO core network entity to use a second MSO core network entity, which is an MSO network interworking entity, as the source for UE policy information to be applied to service provided to the first UE.
